(19) United States
(12) Patent Application Publication
(10) Pub. No.: US 2022/0058167 A1
(43) Pub. Date: Feb. 24, 2022

(54) DEVICE, SYSTEM AND METHOD FOR VERSION ROLLING WITH A BLOCKCHAIN MINING ENGINE

(71) Applicant: Intel Corporation, Santa Clara, CA (US)

(72) Inventors: Vikram Suresh, Portland, OR (US); Sanu Mathew, Portland, OR (US); Raghavan Kumar, Hillsboro, OR (US)

(73) Assignee: Intel Corporation, Santa Clara, CA (US)

(21) Appl. No.: 17/128,836

(22) Filed: Dec. 21, 2020

Related U.S. Application Data
(60) Provisional application No. 63/069,476, filed on Aug. 24, 2020.

(51) Int. Cl. G06F 16/21; G06F 16/22; H04L 9/32

(52) U.S. Cl. CPC G06F 16/219; H04L 9/3239; G06F 16/2255

(57) ABSTRACT

Techniques and mechanisms to facilitate Bitcoin mining operations which support version rolling. In an embodiment, Bitcoin mining circuitry comprises a first scheduler, a first digest, a second scheduler and a second digest arranged in a pipeline configuration. Hash circuitry calculates a first plurality of hashes each based on first bits of a Merkle root, and on a different respective identifier of a Bitcoin protocol version. The first scheduler generates first message schedules each based on second bits of the Merkle root, and on a different respective nonce value. In another embodiment, the first scheduler successively provides the first message schedules to the first digest, wherein, for each such providing of one of the first message schedules, the first digest, second scheduler and second digest successively generate second hashes each based on the provided one of the first message schedules, and on a different respective one of the first hashes.

### CLAIM OF PRIORITY

The present application claims priority under 35 U.S.C. § 119(e) to U.S. Provisional Patent Application Ser. No. 63/069,476 filed Aug. 24, 2020 and entitled “DEVICE, SYSTEM AND METHOD FOR VERSION ROLLING WITH A BLOCKCHAIN MINING ENGINE,” which is herein incorporated by reference in its entirety.

### BACKGROUND

### 1. Technical Field

This disclosure generally relates to Blockchain mining and more particularly, but not exclusively, to mining which performs evaluations for different Blockchain versions.

### 2. Background Art

Bitcoin is a type of digital currency used in de-centralized peer-to-peer transactions. The use of Bitcoin in transactions mitigates the need for intermediate financial institutes because Bitcoin enforces authenticity and user anonymity by employing digital signatures. Bitcoin resolves the “double spending” problem (namely, using the same Bitcoin more than once by a same entity in different transactions) using block chaining, whereas a public ledger records all the transactions that occur within the Bitcoin currency system. Every block added to the block chain validates a new set of transactions by compressing a 1024-bit message which includes a cryptographic root (e.g., the Merkle root) of the transaction along with bits representing other information such as, for example, a time stamp associated with the transaction, a version number, a target, the hash value of the last block in the block chain and a nonce. The process of validating transactions and generating new blocks of the block chain is commonly referred to as Bitcoin mining.

“Mining” is the process of validating transactions and computing new blocks of the chain. One computationally intensive task of mining is finding a 32-bit nonce, which when appended to the Merkle root, previous hash and other headers, produces a 256-bit hash value which is less than a pre-defined threshold value. This hashing operation is the largest recurring cost a miner incurs in the process of creating a Bitcoin and therefore there is a strong motivation to reduce the energy consumption of this process.

Conventional bitcoin mining accelerators that support version rolling implement a spatially shared message scheduler where the output of one message scheduler is physically routed to (n−1) engines in an n-way version rolling. The main disadvantage of spatial scheduler sharing is the routing overhead in physically propagating message scheduler outputs to multiple engines, while managing the complexity of workload scheduling and clock synchronization. Spatial message scheduling is not easily scalable across large number of engines due to routing and signal buffering overhead. Spatially shared message scheduling often leads to inefficient usage of configurable hardware. With n-way version rolling, n−1 scheduler blocks will be active only during non-version rolling mode, but idle otherwise.

### BRIEF DESCRIPTION OF THE DRAWINGS

The various embodiments of the present invention are illustrated by way of example, and not by way of limitation, in the figures of the accompanying drawings and in which:

FIG. 1 illustrates a functional block diagram showing features of a processing system to perform Bitcoin mining by employing resource-efficient hardware accelerators according to an embodiment.

FIG. 2 illustrates a functional block diagram showing features of a device to hash a 1024-bit message into a hash value using three stages of SHA hash in Bitcoin mining according to an embodiment.

FIG. 3 illustrates a functional block diagram showing features of a system to perform Bitcoin mining with version rolling according to an embodiment.

FIG. 4A illustrates a functional block diagram showing features of a system to perform Bitcoin mining with version rolling according to an embodiment.

FIG. 4B illustrates a timing diagram showing a timing of operations by a Bitcoin mining circuit according to an embodiment.

FIGS. 5A and 5B illustrate functional block diagrams each showing respective features of a SHA-256 message digest data path and a SHA-256 message scheduler data path according to an embodiment.

FIG. 6 illustrates a functional block diagram showing features of rounds 57-60 in a SHA hash for Bitcoin mining according to an embodiment.

FIG. 7 illustrates a flow diagram showing features of a method to operate circuitry for Bitcoin mining according to an embodiment.

FIG. 8A is a block diagram illustrating both an exemplary in-order pipeline and an exemplary register renaming, out-of-order issue/execution pipeline according to an embodiment.

FIG. 8B is a block diagram illustrating both an exemplary embodiment of an in-order architecture core and an exemplary register renaming, out-of-order issue/execution architecture core to be included in a processor according to an embodiment.

FIGS. 9A-B illustrate a block diagram of a more specific exemplary in-order core architecture, which core would be one of several logic blocks (including other cores of the same type and/or different types) in a chip.

FIG. 10 is a block diagram of a processor that may have more than one core, may have an integrated memory controller, and may have integrated graphics according to an embodiment.

FIGS. 11-14 are block diagrams of exemplary computer architectures each according to a corresponding embodiment.

FIG. 15 is a block diagram contrasting the use of a software instruction converter to convert binary instructions in a source instruction set to binary instructions in a target instruction set according to an embodiment.

### DETAILED DESCRIPTION

Embodiments of the invention relate generally to Bitcoin mining operations which support version rolling with a scheduler which is temporally shared among workloads each corresponding to a different respective version. In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including circuitry to perform blockchain mining.

Embodiments variously provide a cryptographic hash (e.g., SHA2-256) data path comprising a message scheduler which is “temporally” shared among various workloads for improved energy efficiency in version rolling. Such embodiments are scalable (for example) for an n-way shared scheduler—e.g., where n≥4—with run-time configuration to improve energy-efficiency in Bitcoin mining pools which support version rolling.

Some embodiments provide or otherwise operate based on a temporally shared message scheduler that supports version rolling by sharing the message scheduler output across multiple workloads in time. In some embodiments, a scheduler pipeline is clocked intermittently while newly computed message words are consumed by digest workloads at iso-frequency.

Some embodiments are variously self-contained within each one respective mining engine, and do not require message scheduler output to be physically routed to multiple engines. As a result, such embodiments mitigate signal routing overhead and/or the need for clock synchronization across multiple mining engines. Various embodiments facilitate scaling to larger version rolling by increasing the depth of a FIFO buffer or other suitable circuitry to store intermediate hashes (or “mid-states”). Some embodiments facilitate configurability of mining software to enable/disable or control the depth of version rolling—e.g., while, in one illustrative embodiment, providing 10% improvement in energy-efficiency for 4-way version rolling at (for example)<0.5% area overhead.

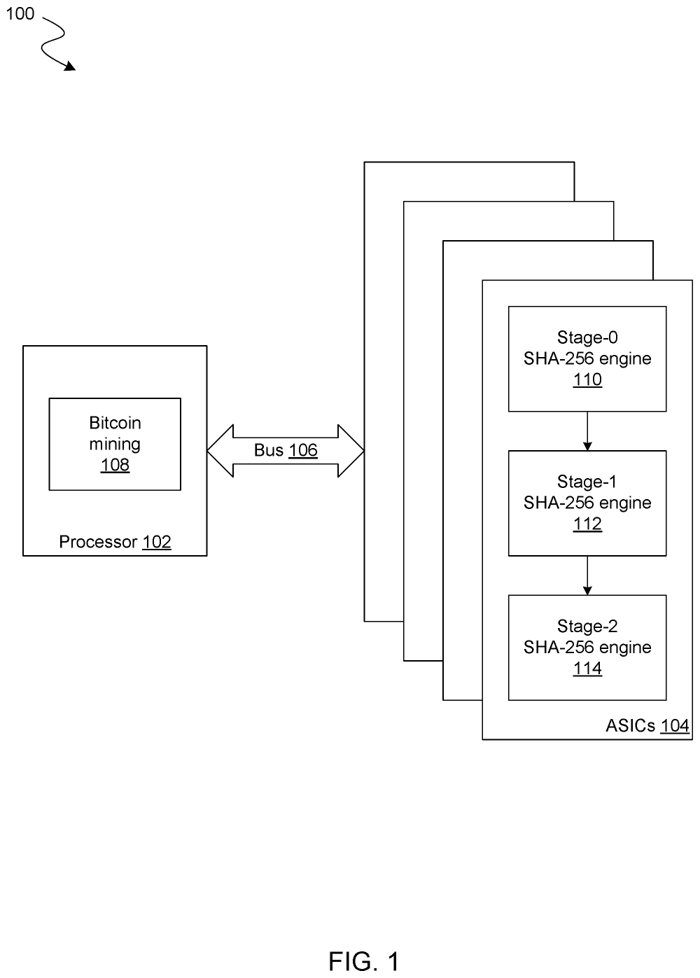

FIG. 1 illustrates a processing system 100 to perform Bitcoin mining by employing an energy-efficient hardware accelerator including (for example) a SHA-256 engine according to an embodiment. As shown in FIG. 1, processing system 100 (e.g., a system-on-a-chip (SOC)) includes a processor 102 and one or more ASICs 104 communicatively coupled to processor 102 via a bus 106. Processor 102 is any of a variety of suitable hardware processing devices such as, for example, a central processing unit (CPU) or a graphic processing unit (GPU) that includes one or more processing cores (not shown) to execute software applications. In the example embodiment shown, processor 102 executes a Bitcoin mining application 108 which implements operations to employ (for example) multi-stages of a SHA-256 hash to compress a 1024-bit input message. For example, Bitcoin mining application 108 delegates the calculation of three stages of SHA-256 hash to hardware accelerators such as, for example, a SHA-256 engine 110 to perform stage-0 hash, a SHA-256 engine 112 to perform stage-1 hash, and a SHA-256 engine 114 to perform stage-2 hash. These SHA-256 engines are implemented on one or more ASICs 104. In one example embodiment, each of the one or more ASICs 104 comprises multiple SHA-256 engines (e.g., >1000) that run in parallel. Some embodiments of the present disclosure take advantage of characteristics of SHA-256 (or other) hash calculation to implement an energy efficient manner of power consumption in Bitcoin mining. In one embodiment, some or all of the SHA-256 engines 110, 112, 114 are variously time multiplexed or otherwise time shared between different workloads each corresponding to different respective bitcoin version information.

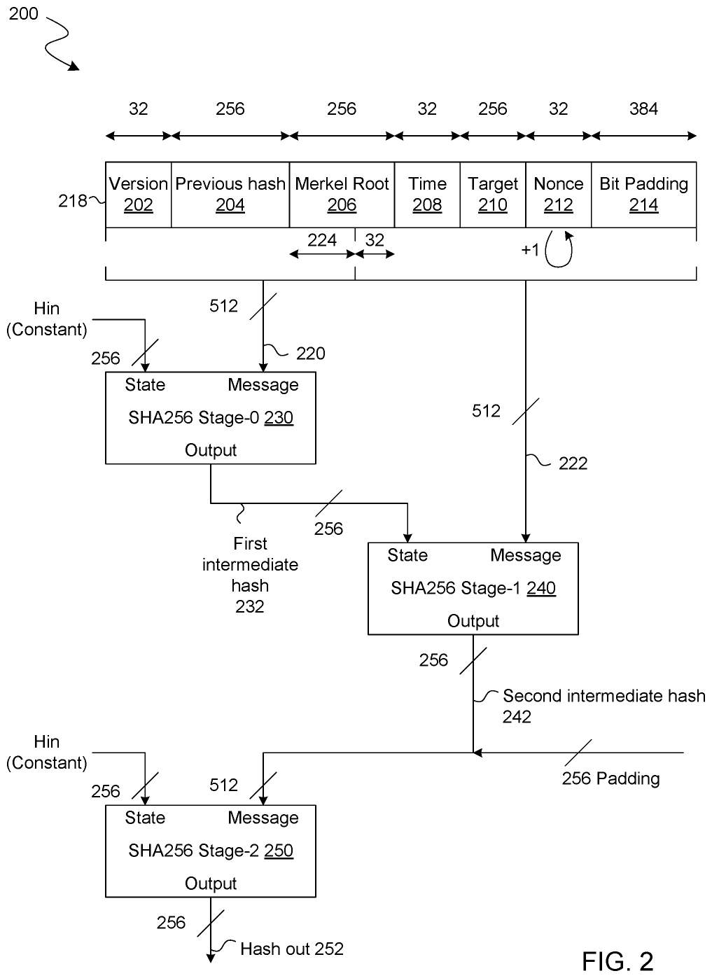

FIG. 2 shows features of a device 200 to perform Bitcoin mining calculations according to an embodiment. In some embodiments, device 200 includes features of system 100—e.g., wherein device 200 provides some or all of SHA-256 engines 110, 112, 114.

In the example embodiment shown, device 200 provides functionality to hash a 1024-bit message into a hash value using three stages of SHA-256 hash employed during Bitcoin mining. In SHA-256 hash, the hash value is stored in eight state registers (a, b, c, d, e, f, g, h) associated with each SHA-256 engine—e.g., where each of the state registers is a hardware register that stores a 32-bit word referred to as a state (represented by A, B, C, D, E, F, G, H). The initial values of these states can be 32-bit constants. Alternatively, the state registers initially store a hash value calculated from a previous iteration of the hashing process. The states (A, B, C, D, E, F, G, H) are updated during SHA-256 hash to generate a hash value as the output. SHA-256 hash consumes a block of 512-bit message, and compresses it into a 256-bit hash stored in state registers (a-h). A typical Bitcoin mining process employs three stages of SHA-256 hash to convert the 1024-bit input message to a 256-bit hash value that is to be be compared to a target value to determine whether a Bitcoin has been identified.

The SHA-256 hash includes 64 rounds (identified as rounds 0, 1, . . . , 63) of applications of compression functions to the states stored in state registers. The compression function employs a 512-bit input value to manipulate the contents stored in registers (a-h). Table 1 illustrates one example of processing by 64 rounds of SHA-256 operations, as applied to the states stored in registers (a-h), to generate a hash value that can be used to determine if a valid nonce is found as a proof of the identification of a Bitcoin.

TABLE 1
SHA-256 compression function to update registers a, b, . . . , h

For j = 0 to 63
{

Compute Ch(e, f, g), Maj(a, b, c), Σ₀(a), Σ₁(e), and Wⱼ
T₁ ← h + Σ₁(e) + Ch(e, f, g) + Kⱼ + Wⱼ
T2 ← Σ₀(a) + Maj(a, b, c)
h ← g
g ← f
f ← e
e ← d + T₁
d ← c
c ← b
b ← a
a ← T₁ + T₂

}

In the above Table 1, logic functions Ch(x, y, z), Maj(x, y, z), Σ₀(x), Σ₁(x) are compression functions that are defined according the SHA-256 specification. Registers (a-h) are initiated each with a respective 32-bit initial value, and Kⱼ, Wⱼ (for j=0, . . . , 63) are 32-bit values derived from a 512-bit message which are part of the 1024-bit input message of the Bitcoin mining.

As shown in FIG. 2, the process performed with device 200 starts with a 1024-bit message 218. The 1024-bit input message 218 comprises header information, a nonce 212, and padding bits 214. The header information includes a 32-bit version number 202, a 256-bit hash value 204 (generated, for example, by an immediately preceding block in the block chain of a Bitcoin public ledger), a 256-bit Merkle root 206 of the transaction, a 32-bit time stamp 208, and a 256-bit target value 210. Version number 202 is an identifier associated with the version of the block chain. Hash value 204 is the hashing result from the immediately preceding block in the block chain recorded in the public ledger. Merkle root 206 is (for example) a 256-bit hash based on all of the transactions in the block. Time stamp 208 represents the time when the current Bitcoin mining process starts. Target value 210 represents a threshold value that the resulting hash value generated by the Bitcoin mining is compared to. For example, if the resulting hash value (“hash out”) is smaller than the target value 210, the nonce 212 in the input message 218 is identified as a valid nonce that can be used as the proof of the identification of a Bitcoin. By contrast, if the final result is no less than the target value 210, the nonce 212 is determined to be invalid, or the Bitcoin mining failed to find a Bitcoin. The value of nonce 212 is successively updated (e.g., incremented by one), and the Bitcoin mining process is repeated to determine the validity of the updated nonce. In version rolling, the value of version 202 is updated (while keeping the other fields the same), and the Bitcoin mining process is repeated to determine the validity of a current nonce value, given the updated version value.

In some embodiments, instead of comparing the final hashing result with the target value, a Bitcoin mining application determines whether the hash out has a minimum number of leading zeros. The minimum number of leading zeros ensures that the final hashing value is smaller than the target value. In some embodiments, the target value (or the number of leading zeros) is changed to adjust the complexity of Bitcoin mining—e.g., where decreasing the target value decreases the probability of finding a valid nonce, and hence increases the overall search space to generate a new block in the block chain. By modifying the target value 210, the complexity of the Bitcoin mining is adjusted to ensure that the time used to find a valid nonce is relative constant (in a typical application, approximately 10 minutes). For a given header, the Bitcoin mining application sweeps through the search space of 2³² possibilities to find a valid nonce. The Bitcoin mining process includes a series of mining iterations to sweep through these possibilities of valid nonce. In version rolling, the nonce 212 and version value 202 are variously updated (e.g., incremented) while other header information is kept the same through the various mining iterations.

In the example embodiment show, Bitcoin mining calculations to find a valid nonce includes three stages of SHA-256 hash calculations—e.g., the three stages implemented by the illustrative Stage-0 circuit block 230, Stage-1 circuit block 240, and Stage-2 circuit block 250 shown. Referring to FIG. 2, at the SHA-256 Stage-0 circuit block 230, the state (A, B, C, D, E, F, G, H) stored in state registers (a, b, c, d, e, f, g, h) is initiated with eight 32-bit constants. Furthermore, SHA-256 Stage-0 circuit block 230 receives 512 bits of input message portion 220 including the 32-bit version number 202, 256-bit hash value 204 from the last block in the block chain, and a portion (e.g., the first 224 bits) of Merkle root 206. Based on message portion 220 and the eight 32-bit constants, SHA-256 Stage-0 circuit block 230 produces a first 256-bit intermediate hash value 232. The first intermediate hash value 232 is then employed to initiate state registers (a, b, c, d, e, f, g, h) of SHA-256 Stage-1 circuit block 240.

Another 512 bits of input message portion 222, provided to SHA-256 Stage-1 circuit block 240, includes the remaining portion (32 bits) of the Merkle root 206, 32-bit time stamp 208, 256-bit target value 210, 32-bit nonce 212, and 128 padding bits 214. Based on message portions 222, 232, SHA-256 Stage-1 circuit block 240 produces a second 256-bit intermediate hash value 242.

At SHA-256 Stage-2 circuit block 250, the state registers (a, b, c, d, e, f, g, h) thereof are set with the same 256-bit constant which is provided to SHA-256 Stage-0 circuit block 230. A 512-bit input message to SHA-256 Stage-2 circuit block 250 includes the second 256-bit intermediate hash 242 (from SHA-256 Stage-1 circuit block 240) which has been padded with 256 padding bits. Based on the 256-bit constant and the padded version of the message from SHA-256 Stage-1 circuit block 240, SHA-256 Stage-2 circuit block 250 provides a third 256-bit hash value as the hash out 252 for the three stages of SHA-256 hash. In various embodiments, a Bitcoin mining application (not shown), for example, then determines whether hash out 252 is smaller than the target value 210. If the hash out 252 is smaller than the target value 210, the nonce 212 in the input message is identified as a valid nonce. By contrast, if the hash out is not less than the target value 210, the nonce 212 is determined to be an invalid nonce, and is incremented or otherwise updated in preparation for a next hashing process to determine the validity of the updated nonce 212 using the process similar to that shown in FIG. 2.

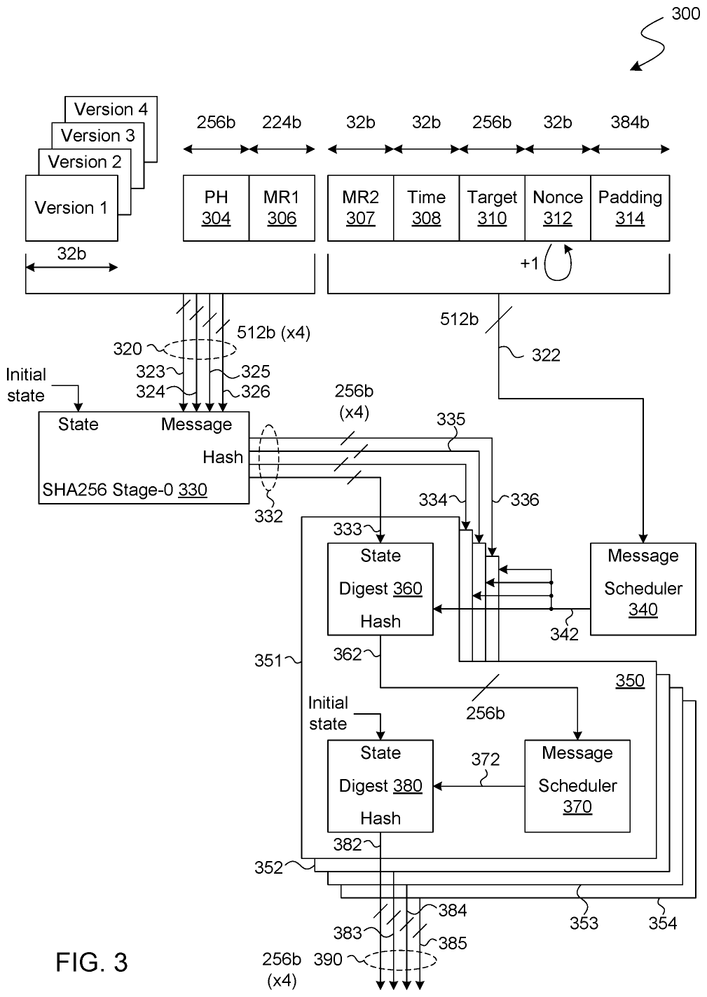

FIG. 3 shows features of a device 300 to facilitate version rolling for Bitcoin mining operations according to an embodiment. Device 300 is one example of an embodiment wherein a message scheduler is temporally shared among workloads which each correspond to a different respective one of multiple Bitcoin versions for which version rolling is to be performed. In various embodiments, device 300 includes features of system 100 or device 200, for example.

As shown in FIG. 3, device 300 comprises hash circuitry 330, a scheduler 340, and an engine 350 which is coupled to hash circuitry 330 and scheduler 340. Engine 350 comprises an in-series arrangement of a digest 360, a scheduler 370, and a digest 380. In one example embodiment, hash circuitry 330 provides functionality of circuit block 230—e.g., wherein functionality such as that of circuit block 240 is provided with scheduler 340 and digest 360, and where functionality such as that of circuit block 250 is provided with scheduler 370 and digest 380.

Scheduler 340 is coupled to receive a portion of a message (or “message portion”) 322 which, for example, includes bits MR2 307 of a Merkle root, a time stamp 308, a target value 310, a nonce 312, and padding bits 314. In one such embodiment, scheduler 340 successively receives updated versions of message portion 322 over time—e.g., where each such version of message portion 322 includes an incremented or otherwise updated value of nonce 312. Based on a given message portion 322, scheduler 340 generate a corresponding message schedule 342 which is to be provided to engine 350.

Hash circuitry 330 is coupled to variously receive (e.g., successively) message portions 320 which, for example, each include a previous hash (PH) 304, other bits MR1 306 of the same Merkle root, and a different respective one of multiple version numbers (e.g., represented by the illustrative Versions 1-4 shown) which indicate a corresponding Bitcoin protocol version. For example, an intermediate hash 333 of message portions 320 includes a version number for a Version 1 of a Bitcoin protocol—e.g., wherein message portions 334, 335, 336 of message portions 320 includes version numbers for Versions 2, 3, and 4 (respectively). Based on message portions 320, hash circuitry 330 generates (e.g., successively) intermediate hashes 332 which are each based on both an initial state input, and on a different respective one of the message portions 320. By way of illustration and not limitation, a hash 333 of intermediate hashes 332 is generated by hash circuitry 330 based on message portion 323—e.g., wherein hash circuitry 330 subsequently generates hashes 334, 335, 336 based on message portions 324, 325, 326 (respectively).

For a given value of nonce 312 (and for a given message portion 322 which includes that given nonce value), engine 350 successively performs multiple Bitcoin mining workloads—e.g., including the illustrative workloads 351, 352, 353, 354 shown—which are each based on both the corresponding message schedule 342 and on a different respective one of intermediate hashes 332. For example, workloads 351, 352, 353, 354 are performed using hashes 333, 334, 335, 336 (respectively). Although workloads 351-354 are variously represented as different blocks in FIG. 3, it is to be noted that each of workloads 351-354 is performed with engine 350—e.g., where said workloads are variously performed each with digest 360, scheduler 370, and digest 380. In other words, the same hardware of engine 350 performs the multiple workloads 351, 352, 353, 354 at different respective periods of time each for the same nonce value (and for different respective protocol versions).

In workload 351, digest 360 performs hash calculations to generate, based on message schedule 342 and intermediate hash 333, a 256-bit hash 362 which is provided to scheduler 370. Workload 351 further comprises scheduler 370 generating another message schedule 372 based on hash 362, wherein message schedule 372 is provided by scheduler 370 to digest 380. Based on message schedule 372 and the initial state input, digest 380 performs further hash calculations to generate another 256-bit hash 382.

Workloads 352, 353, 354 include similar operations by engine 350 to generate respective ones of hashes 390. For example, in workload 352, digest 360 performs hash calculations to generate a respective second hash, based on message schedule 342 and intermediate hash 334. Based on this respective second hash, scheduler 370 generates a respective second message schedule, which is a basis for digest 380 to perform further hash calculations to generate a 256-bit hash 383.

Alternatively, or in addition, in workload 353, digest 360 performs hash calculations to generate a respective second hash, based on message schedule 342 and intermediate hash 335. Based on this respective second hash, scheduler 370 generates a respective second message schedule, which is a basis for digest 380 to perform further hash calculations to generate a 256-bit hash 384.

Alternatively, or in addition, in workload 354, digest 360 performs hash calculations to generate a respective second hash, based on message schedule 342 and intermediate hash 336. Based on this respective second hash, scheduler 370 generates a respective second message schedule, which is a basis for digest 380 to perform further hash calculations to generate a 256-bit hash 385.

In an embodiment, hashes 390 are variously provided to evaluation hardware and/or software (such as Bitcoin mining application 108) which evaluates whether a condition indicated by target 310 has been met. For example, the process of mining is typically to identify a nonce for a given header which generates a final hash that is lesser than a pre-defined target. This is often achieved by looking for a minimum number of leading zeros that would ensure the hash to be smaller than the target. The target, and hence the leading zero requirement changes depending on the rate of new block creation to maintain the rate at 1 block every 10 minutes. Decreasing the target decreases the probability of finding a valid hash and hence increases the overall search space to generate a new block for the chain. For a given header, device 300 sweeps through the search space of 2³² options to potentially find a valid nonce. If no valid nonce is found, the Merkle root (comprising bits MR1 306 and bits 307) is changed by choosing a different set of pending transactions and starting over with the nonce search.

In some embodiments, a repository (not shown) which, for example, is provided at hash circuitry 330 (or alternatively, is coupled between hash circuitry 330 and engine 350) stores intermediate hashes 332 each for repeated use by engine 350 in servicing various workloads including workload which are each based on a different respective version of message portion 322. Such a repository includes data storage circuitry (e.g., including registers, a memory array and/or any of a variety of other suitable circuit resources) to buffer or otherwise provide access to intermediate hashes 332. In one such embodiment, the repository further comprises (or alternatively, is to be coupled to) control circuitry which determines an order and timing according to which intermediate hashes 332 are each to be provided to digest 360. In providing such a repository, in combination with a scheduler 340 which is temporally shared across multiple workloads by engine 350, some embodiments mitigate signal routing and/or clock timing constraints that would otherwise constrain Bitcoin mining functionality.

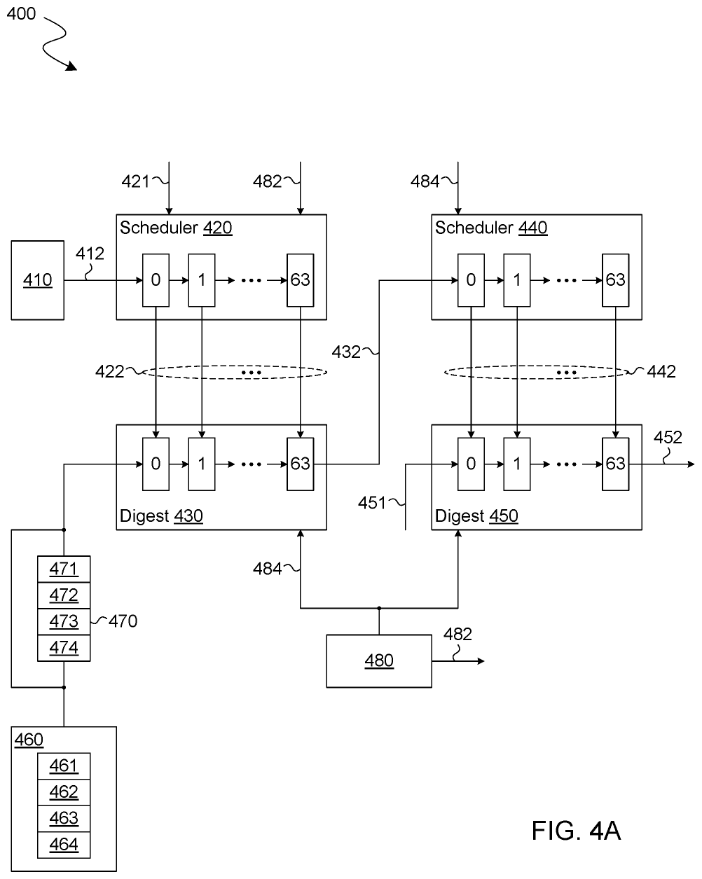

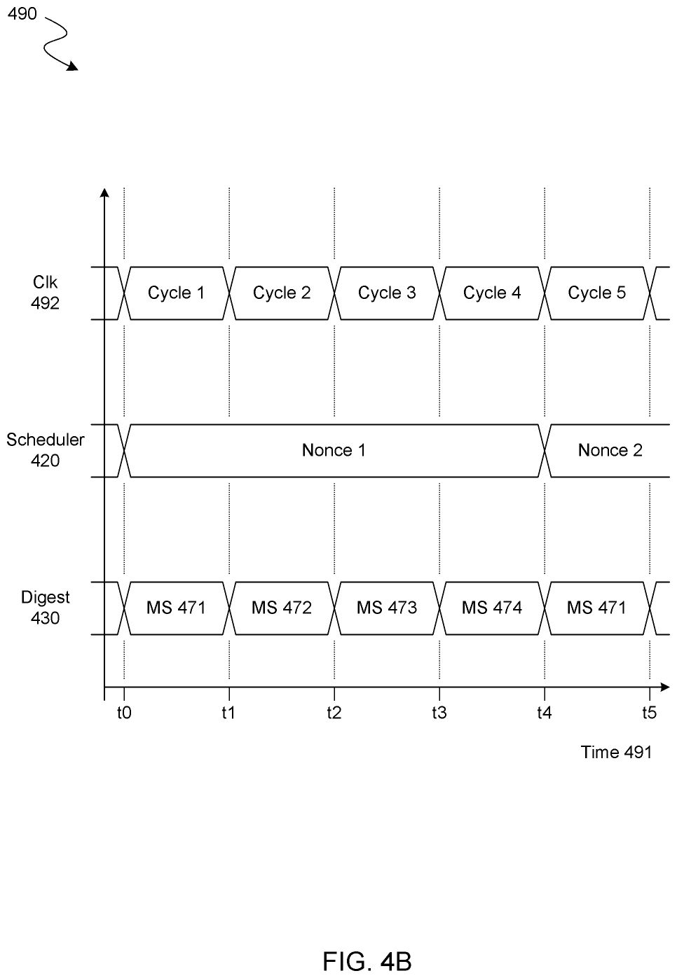

FIG. 4A shows features of a system 400 to provide a temporally shared message scheduler for Bitcoin mining operations according to an embodiment. System 400 illustrates an embodiment wherein a message scheduler is temporally shared across multiple workloads by a Bitcoin mining engine, and wherein intermediate hashes (“mid-states”)—each based on a different respective protocol version identifier—are variously provided repeatedly to the Bitcoin mining engine over multiple workloads. In various embodiments, system 400 provides functionality such as that of system 100, device 200, or device 300.

In the example embodiment illustrated by FIG. 4A, system 400 supports 4-way version rolling, wherein different mid-states are programmed into a mid-state FIFO of a Bitcoin mining engine. For example, system 400 comprises first message scheduler circuitry 420, first message digest circuitry 430, second message scheduler circuitry 440, and second message digest circuitry 450 which are coupled in a pipeline configuration.

A nonce generator circuitry 410 of system 400 illustrates any of various suitable circuit resources which are coupled to generate, and successively provide multiple nonce values 412 to first message scheduler circuitry 420. First message scheduler circuitry 420 is further coupled to receive information including, for example, fields of message 218 (other than nonce 212), and—in some embodiments—an initial constant state such as that received by circuit block 230.

For a given nonce value of multiple nonce values 412, first message scheduler circuitry 420 successively generates a respective first message schedule 422 which is based on said nonce value and information 421. For example, the respective first message schedule 422 comprises i+1 words {Wᵢ}—e.g., where the index i ranges from 0 to 63, in some embodiments.

The first message scheduler circuitry 420 provides the respective first message schedule 422 to the first message digest circuitry 430 for use in successively generating hashes which each correspond to a different respective mid-state hash (and accordingly, which further correspond to a different respective protocol version). For example, system 400 further comprises—or alternatively, is coupled to—a circuit resource (such as the illustrative hash circuitry 460 shown) which is operable to generate multiple mid-state hashes each based on a different respective identifier of a protocol version. By way of illustration and not limitation, a hash circuitry 460 generates first (mid-state) hashes 471, 472, 473, 474 based on version identifiers 461, 462, 463, 464 (respectively). In an embodiment, system 400 further comprises—or alternatively, is coupled to—buffer circuitry 470 (such as a FIFO buffer) which facilitates a repeated sequential provisioning of a plurality of first (mid-state) hashes 471, 472, 473, 474 to first message digest circuitry 430. A feedback path enables hashes 471, 472, 473, 474 to be variously debuffered from a top of buffer 470, and rebuffered to a bottom of buffer 470—e.g., to facilitate hashes 471, 472, 473, 474 being repeatedly provided to first message digest circuitry 430 in a particular order.

The first message digest circuitry 430 successively receives the plurality of first (mid-state) hashes 471, 472, 473, 474 and, based on the respective first message schedule 422, successively generates a respective plurality of second hashes (successively provided via path 432) which each correspond to the same one of nonce value 412. More particularly, the respective plurality of second hashes are each based on the nonce value and a different respective hash of the plurality of first hashes 471, 472, 473, 474. With the second message scheduler circuitry 440, and the second message digest circuitry 450, system 400 successively generates a respective plurality of third hashes (successively provided via path 452) which are each based on a different respective hash of the respective plurality of second hashes. For example, for each of respective plurality of second hashes, second message scheduler circuitry 440 generates a respective second message schedule 442. In turn, based on the respective second message schedule 442 (and further based on some initial state information 451), second message digest circuitry 450 generates a corresponding hash of the respective plurality of third hashes (successively provided via path 452).

After generating one respective plurality of third hashes (where each such hash is based on a given nonce value of the multiple nonce values 412 and on a different respective one of the first hashes 471, 472, 473, 474), first message scheduler circuitry 420 receives a next one of the multiple nonce values 412 to facilitate the generating of a next respective plurality of third hashes 452—e.g., where each such hash is based on said next nonce value and on a different respective one of the first hashes 471, 472, 473, 474.

In some implementations, multiple digest rounds (in this example, 64 digest rounds) are fully unrolled—e.g., where a new mid-state is needed for each cycle. Alternatively, one single round hardware iterates over a given mid-state for 64-cycles. In the example embodiment shown, a new mid-state is fed once every 64 cycles. In case of a fully pipelined unrolled datapath, a scheduler—in some embodiments—receives a next nonce value to be processed before the third hash for the preceding hash has been determined.

In some embodiments, system 400 further comprises—or alternatively, is coupled to—a controller 480 which comprises an application specific integrated circuitry, a programmable gate array, and/or any of various other suitable circuit structures to provide clock signaling (e.g., including the illustrative clock signals 482, 484 shown) that, for example, provides timing characteristics such as that shown in FIG. 4B.

FIG. 4B shows a timing diagram 490 which illustrates a coordination of circuitry to facilitate Bitcoin mining with version rolling according to an embodiment. Circuit operations such as those illustrated by timing diagram 490 are provided, for example, with system 400.

As shown in FIG. 4B, timing diagram 490 shows operational characteristics, over a period of time 491, for first message scheduler circuitry 420, first message digest circuitry 430, and a clock signal Clk 492 which is provided (for example) to clock one or more of first message digest circuitry 430, second message scheduler circuitry 440, and second message digest circuitry 450.

In timing diagram 490, first message scheduler circuitry 420 is clocked at a first frequency, while first message digest circuitry 430 (and, for example, second message scheduler circuitry 440 and/or second message digest circuitry 450) is clocked, based on clock signal Clk 492, at a second frequency which is equal to some integer multiple of the first frequency. In one such embodiment, the integer—which is greater than one—is equal to a total number of version identifier values for which version rolling is being performed.

By way of illustration and not limitation, during a first clocking cycle of first message scheduler circuitry 420 (which is from time t0 to time t4), first message scheduler circuitry 420 provides one message schedule which is based on a first nonce value. That single clocking cycle of first message scheduler circuitry 420 spans four clocking cycles for first message digest circuitry 430. During said four clocking cycles, first message digest circuitry 430 successively generates a first plurality of hashes (more particularly, message digest outputs) which are each based on the message schedule for the first nonce value, and on a different respective one of hashes 471, 472, 473, 474.

Subsequently, during a next clocking cycle of first message scheduler circuitry 420 (which starts at time t4), first message scheduler circuitry 420 provides another single message schedule which is based on a second nonce value. During this next clocking cycle of first message scheduler circuitry 420, first message digest circuitry 430 successively generates a second plurality of hashes which are each based on the message schedule for the second nonce value, and on a different respective one of hashes 471, 472, 473, 474.

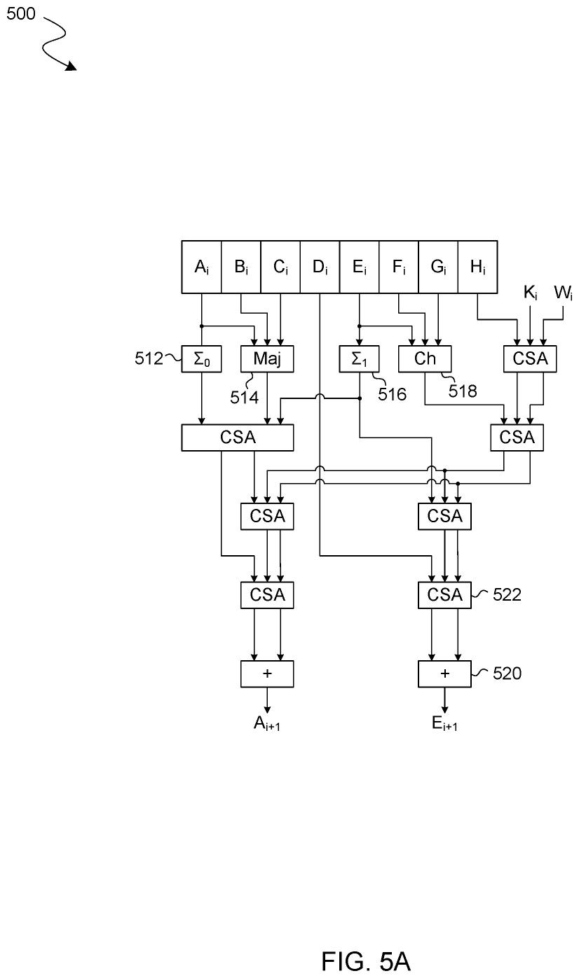

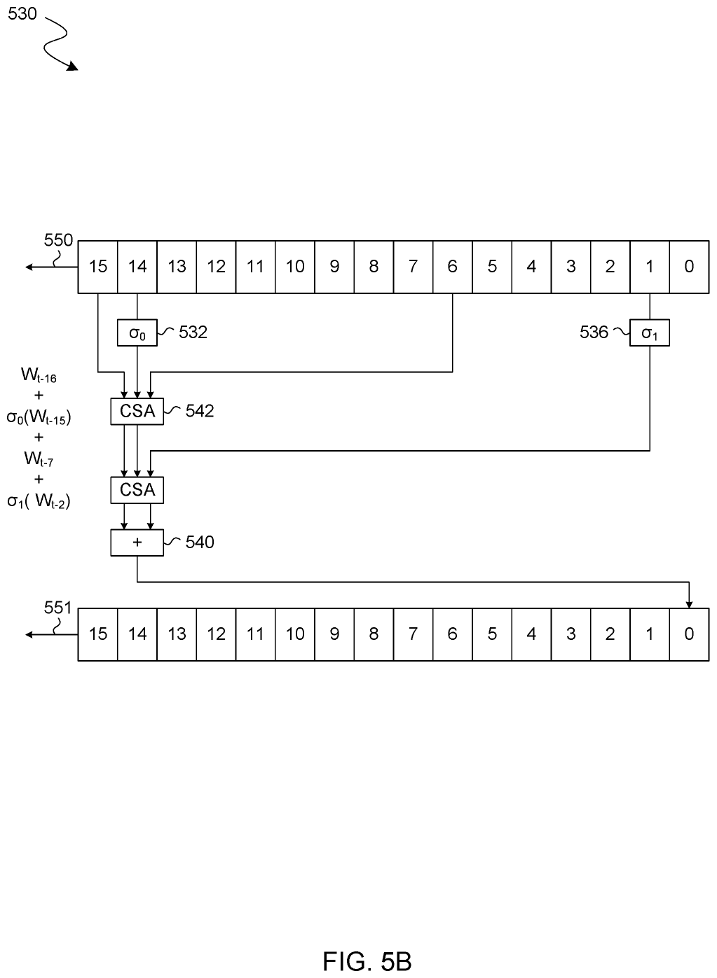

FIGS. 5A, 5B show a message digest data path 500 and a message scheduler data path 530 (respectively) each of circuitry to calculate a Secure Hash Algorithm (SHA) 256 (SHA-256) hash according to an embodiment. In an example embodiment, message scheduler data path 530 provides functionality of scheduler 340 (or scheduler 370)—e.g., wherein message digest data path 500 provides functionality of digest 360 (or digest 380).

A processing engine in a Bitcoin mining accelerator exercises message digest data path 500 and message scheduler data path 530 over numerous rounds (e.g., 220 rounds in some embodiments). In some embodiments, message digest data path 510 and/or message scheduler data path 530 employ a bit-sliced design.

Message digest data path 500 comprises: one or more first circuitries 512, which are operable to perform a “Σ₀” calculation; one or more second circuitries 514, which are operable to perform a “Maj” calculation; one or more third circuitries 516, which are operable to perform a “Σ₁” calculation; one or more fourth circuitries 518, which are operable to perform a “Ch” calculation; and/or one or more fifth circuitries 520, which are operable to perform a “+” calculation (e.g., an addition with carry propagation operation); and one or more sixth circuitries 522, which are operable to perform one or more “CSA” calculations (e.g., carry-save addition calculations). These operations are performed on internal states Aᵢ through Hᵢ, an expanded message word Wᵢ, a round constant Kᵢ, and/or on outputs of first circuitries 512 through sixth circuitries 522 (for example, as depicted in FIG. 5A).

Message scheduler data path 530 comprises: one or more first circuitries 532, which are operable to perform a “σ₀” calculation; one or more second circuitries 536, which are operable to perform a “σ₁” calculation; one or more third circuitries 540, which are operable to perform a “+” calculation (e.g., an addition with carry propagation operation); and one or more fourth circuitries 542, which are operable to perform one or more “CSA” calculations (e.g., carry-save addition calculations). These operations are performed on portions 0 through 15 of a message word, and/or on outputs of first circuitries 532 through fourth circuitries 542 (for example, as depicted in FIG. 5B).

Accordingly, the circuitries perform Boolean sum-of-products calculations for outputs of a “Σ₀” calculation, a “Maj” calculation, a “Σ₁” calculation, a “Ch” calculation, and/or a “+” calculation (as discussed above regarding message digest data path 500). In addition, the circuitries perform Boolean sum-of-products calculations for outputs of a “σ₀” calculation, a “σ₁” calculation, and/or a “+” calculation (as discussed above regarding message scheduler data path 530). In one such embodiment, first bits processed by message scheduler data path 530, to generate second bits, are provided in a first message word 550 to message digest data path 500, where said second bits are further provided in a second message word 551 to message digest data path 500.

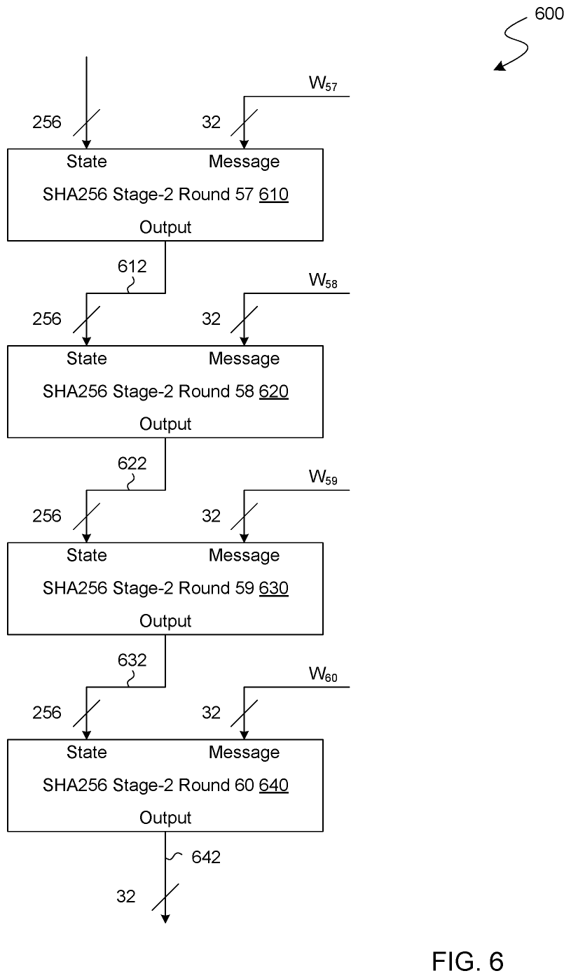

FIG. 6 shows features of message digest circuitry 600 to calculate a hash according to an embodiment. In various embodiments, message digest circuitry 600 includes features of one of circuit block 250, digest 380, or second message digest circuitry 450 (for example).

As shown in FIG. 6, message digest circuitry 600 comprises an in-series arrangement of circuit blocks 610, 620, 630, 640 to perform (respectively) rounds 57-60 of a SHA-256 hash. For each of circuit blocks 610, 620, 630, 640, the circuit block performs a respective round of the SHA-256 hash computation by the application of compression functions to a respective 256-bit of data stored in respective registers (a, b, c, d, e, f, g, h). Circuit blocks 610, 620, 630, 640 each receive a corresponding 32-bit word Wⱼ (where the index j=57, . . . , 60, and where each word Wⱼ is derived from a corresponding 512-bit message schedule) as a key to the respective compression functions. Successive outputs 612, 622, 632 from circuit blocks 610, 620, 630 are variously processed each by a respective next circuit block, resulting in calculation of a 32-bit value 642 which (for example) corresponds to the register e for round 60.

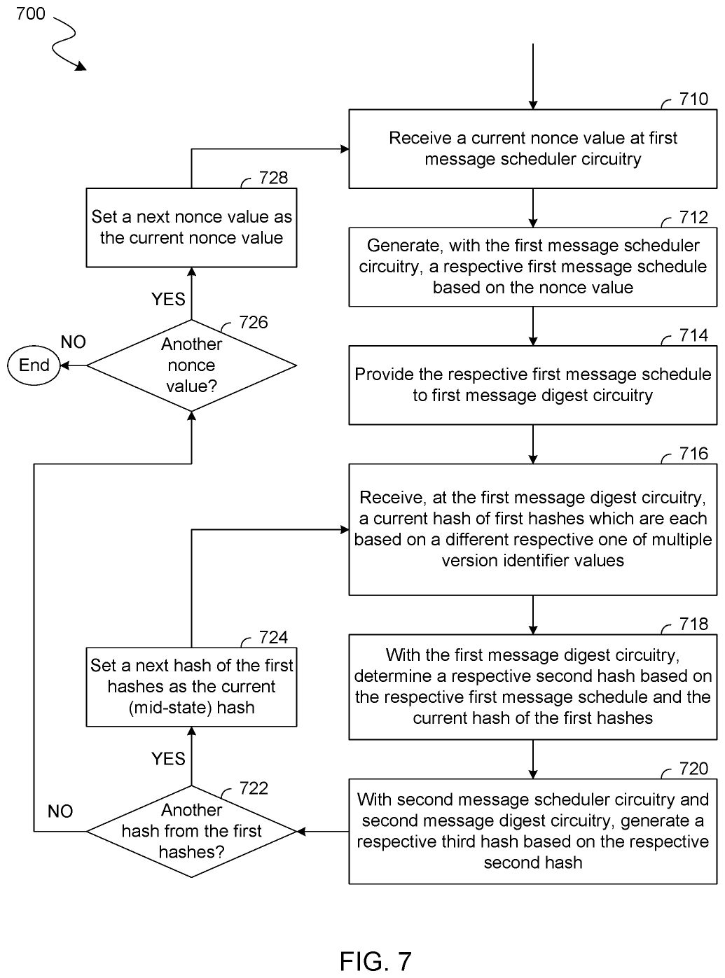

FIG. 7 shows features of a method 700 to operate circuitry for Bitcoin mining according to an embodiment. In various embodiments, method 700 is performed with one of systems 100, 400 or one of devices 200, 300, for example.

As shown in FIG. 7, method 700 comprises (at 710) receiving a current nonce value at first message scheduler circuitry. The first message scheduler circuitry is coupled—in an in-series configuration—with first message digest circuitry, second message scheduler circuitry and second message digest circuitry. Method 700 further comprises (at 712) generating, with the first message scheduler circuitry, a respective first message schedule based on the nonce value.

In an embodiment, during method 700, the first message scheduler circuitry successively generates a first plurality of message schedules each based on a different respective nonce value. For example, the first message scheduler circuitry successively receives multiple message portions (e.g., multiple successively updated versions of message portion 322) during method 700, where said message portions each include first bits of a Merkle root, and a different respective nonce value (e.g., where such successive receiving includes multiple instances of the receiving at 710). In one such embodiment, method 700 successively performs respective operations for each message schedule of said first plurality of message schedules. Such respective operations include, for example, first message digest circuitry successively generating respective second plurality of hashes each based on both a different respective one of the first plurality of hashes, and the message schedule in question. Furthermore, such operations include the second message scheduler circuitry successively generating respective second plurality of message schedules each based on a different respective one of the respective second plurality of hashes. Further still, such operations include the second message digest circuitry successively generating a respective third plurality of hashes each based on a different respective one of the respective second plurality of message schedules.

For example, referring again to FIG. 7, method 700 further comprises (at 714) providing the respective first message schedule (the one most recently generated at 712) to the first message digest circuitry. Method 700 further comprises (at 716) receiving, at the first message digest circuitry, a current hash of first hashes (e.g., one of hashes 332) which are each based on a different respective one of multiple version identifier values. Method 700 further comprises (at 718) determining a respective second hash (e.g., hash 362), with the first message digest circuitry, based on the respective first message schedule and the current hash of the first hashes. Method 700 further comprises (at 720) generating a respective third hash (e.g., one of hashes 390), with second message scheduler circuitry and second message digest circuitry, based on the respective second hash.

Method 700 further comprises determining (at 722) whether any other hash from the first hashes remains to be used for generating a respective second and third hashes based on the respective first message schedule for the current nonce. Where it is determined at 722 that another such hash from the first hashes remains to be used, method 700 (at 724) sets a next hash of the first hashes to be the current hash, where said current hash is received at a next performance of the receiving at 716.

Where it is instead determined at 722 that no such hash from the first hashes remains to be used, method 700 (at 726) determines whether any other nonce value is to be used for Bitcoin mining processing. Where it is instead determined at 726 that no such nonce value remains to be used, method 700 ends (or, in another embodiment, repeats to perform Bitcoin mining based on other message information). Where it is determined at 726 that such a nonce value remains to be used, method 700 (at 728) sets a next nonce value as the current nonce value, before returning to repeat the receiving at 710.

The figures described herein detail exemplary architectures and systems to implement embodiments of the above. In some embodiments, one or more hardware components and/or instructions described herein are emulated as detailed below, or implemented as software modules.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

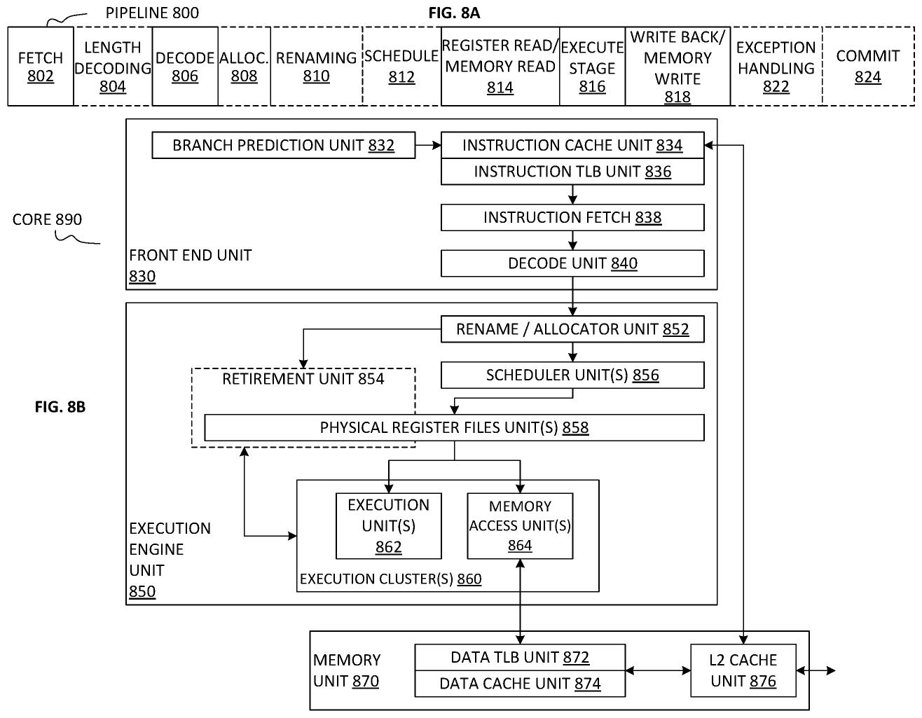

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 includes a branch prediction unit 832 coupled to an instruction cache unit 834, which is coupled to an instruction translation lookaside buffer (TLB) 836, which is coupled to an instruction fetch unit 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect, or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 858 comprises a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 856, physical register file(s) unit(s) 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 864). It should also be understood that where separate pipelines are used, one or more of these pipelines may be out-of-order issue/execution and the rest in-order.

The set of memory access units 864 is coupled to the memory unit 870, which includes a data TLB unit 872 coupled to a data cache unit 874 coupled to a level 2 (L2) cache unit 876. In one exemplary embodiment, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 834/874 and a shared L2 cache unit 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

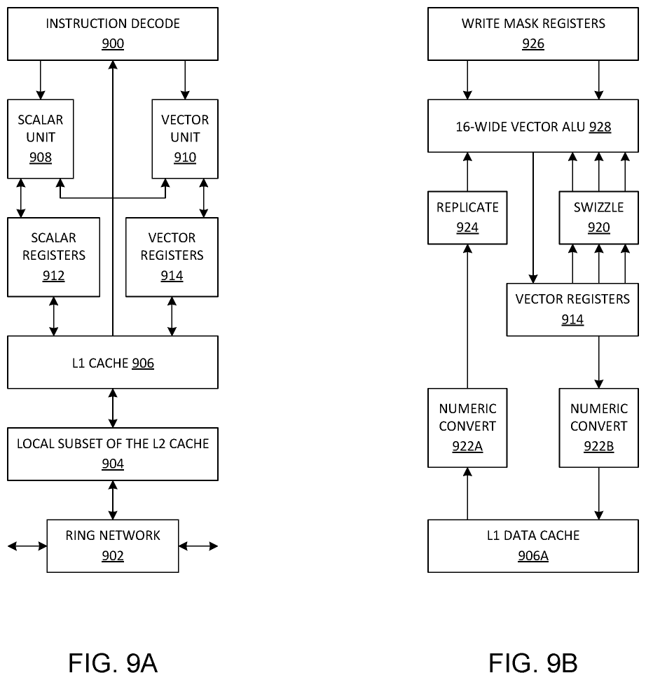

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 902 and with its local subset of the Level 2 (L2) cache 904, according to embodiments of the invention. In one embodiment, an instruction decoder 900 supports the x86 instruction set with a packed data instruction set extension. An L1 cache 906 allows low-latency accesses to cache memory into the scalar and vector units. While in one embodiment (to simplify the design), a scalar unit 908 and a vector unit 910 use separate register sets (respectively, scalar registers 912 and vector registers 914) and data transferred between them is written to memory and then read back in from a level 1 (L1) cache 906, alternative embodiments of the invention may use a different approach (e.g., use a single register set or include a communication path that allow data to be transferred between the two register files without being written and read back).

The local subset of the L2 cache 904 is part of a global L2 cache that is divided into separate local subsets, one per processor core. Each processor core has a direct access path to its own local subset of the L2 cache 904. Data read by a processor core is stored in its L2 cache subset 904 and can be accessed quickly, in parallel with other processor cores accessing their own local L2 cache subsets. Data written by a processor core is stored in its own L2 cache subset 904 and is flushed from other subsets, if necessary. The ring network ensures coherency for shared data. The ring network is bi-directional to allow agents such as processor cores, L2 caches and other logic blocks to communicate with each other within the chip. Each ring datapath is 1012-bits wide per direction.

FIG. 9B is an expanded view of part of the processor core in FIG. 9A according to embodiments of the invention. FIG. 9B includes an L1 data cache 906A part of the L1 cache 906, as well as more detail regarding the vector unit 910 and the vector registers 914. Specifically, the vector unit 910 is a 16-wide vector processing unit (VPU) (see the 16-wide ALU 928), which executes one or more of integer, single-precision float, and double-precision float instructions. The VPU supports swizzling the register inputs with swizzle unit 920, numeric conversion with numeric convert units 922A-B, and replication with replication unit 924 on the memory input. Write mask registers 926 allow predicating resulting vector writes.

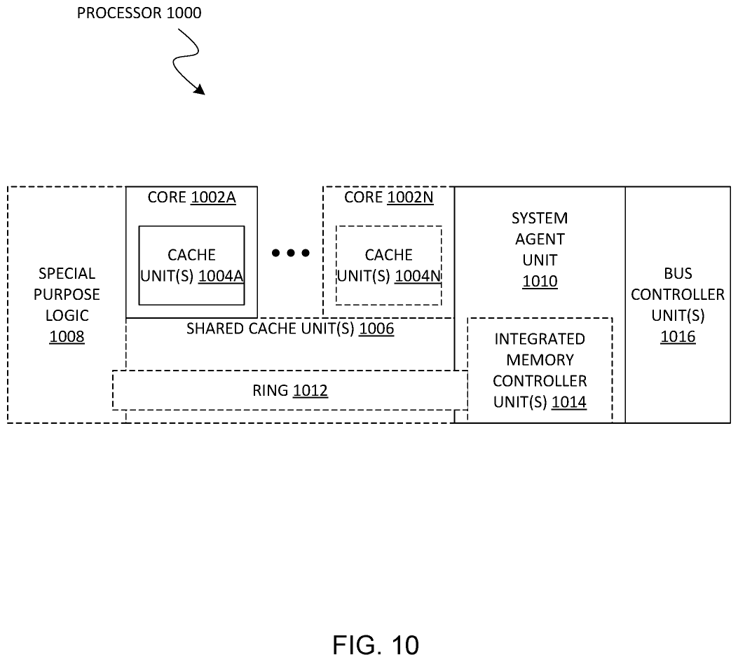

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes respective one or more levels of caches 1004A-N within cores 1002A-N, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the special purpose logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multithreading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

### Exemplary Computer Architectures

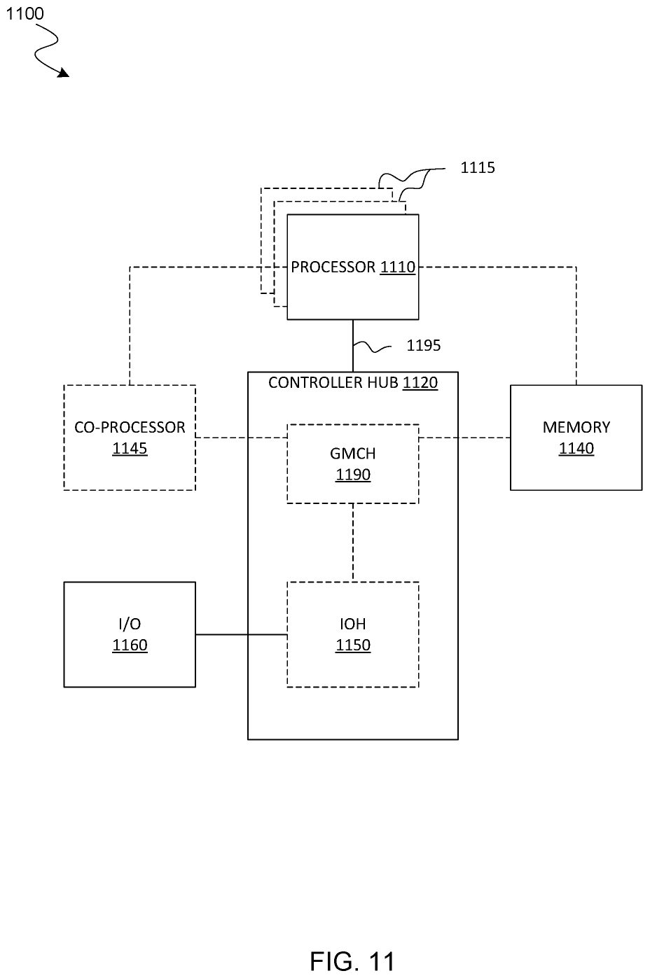

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the processors 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

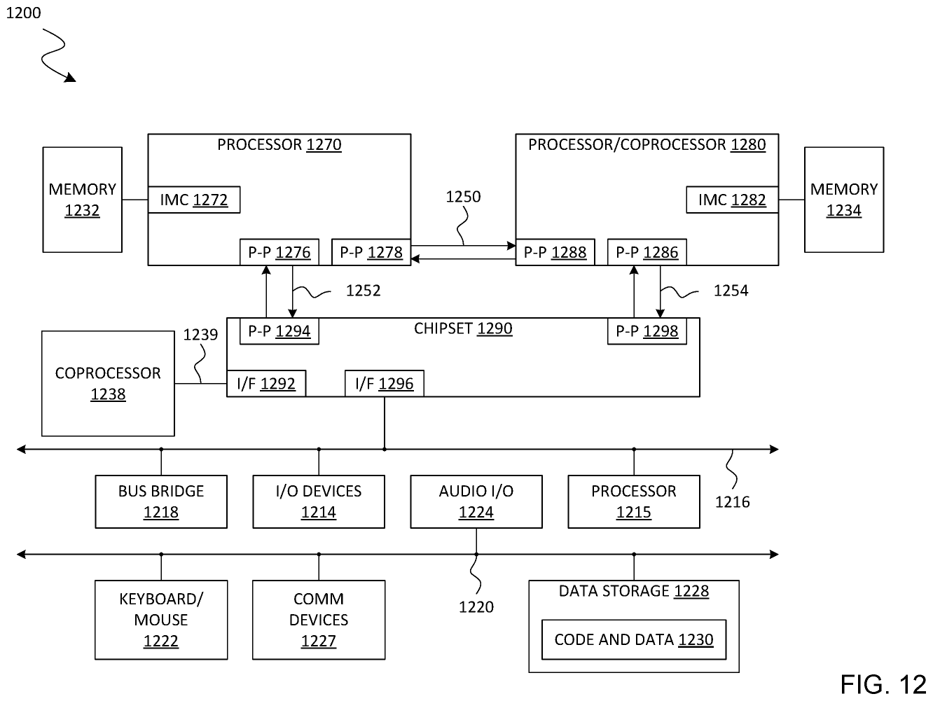

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) units 1272 and 1282, respectively. Processor 1270 also includes as part of its bus controller unit's point-to-point (P-P) interfaces 1276 and 1278; similarly, second processor 1280 includes P-P interfaces 1286 and 1288. Processors 1270, 1280 may exchange information via a point-to-point (P-P) interconnect 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1292 and an interconnect 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

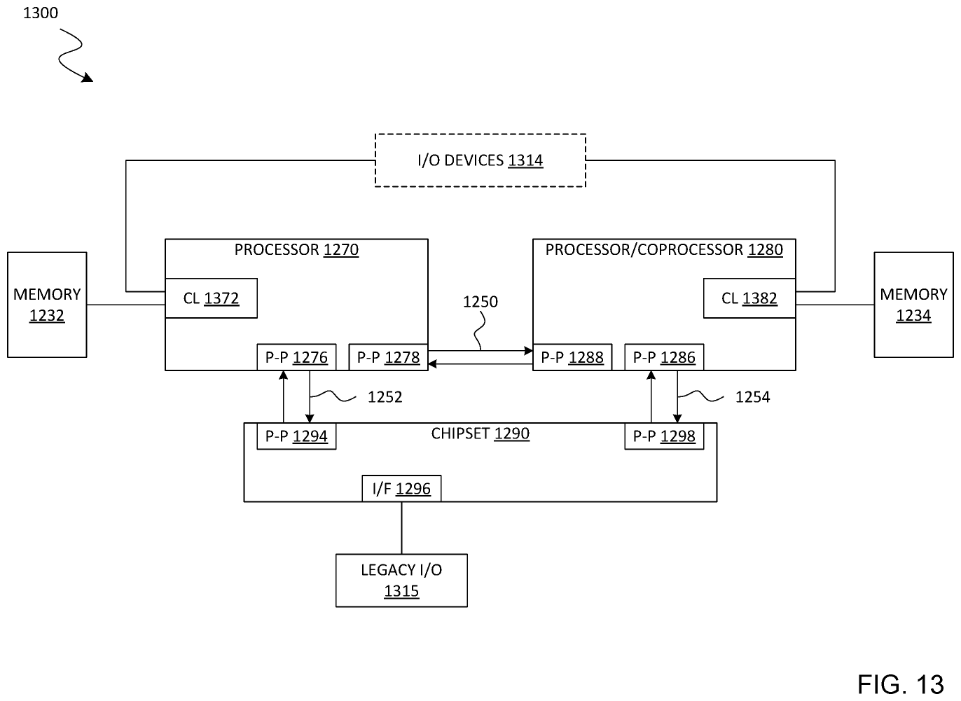

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1372 and 1382, respectively. Thus, the CL 1372, 1382 include integrated memory controller units and include I/O control logic. FIG. 13 illustrates that not only are the memories 1232, 1234 coupled to the CL 1372, 1382, but also that I/O devices 1314 are also coupled to the control logic 1372, 1382. Legacy I/O devices 1315 are coupled to the chipset 1290.

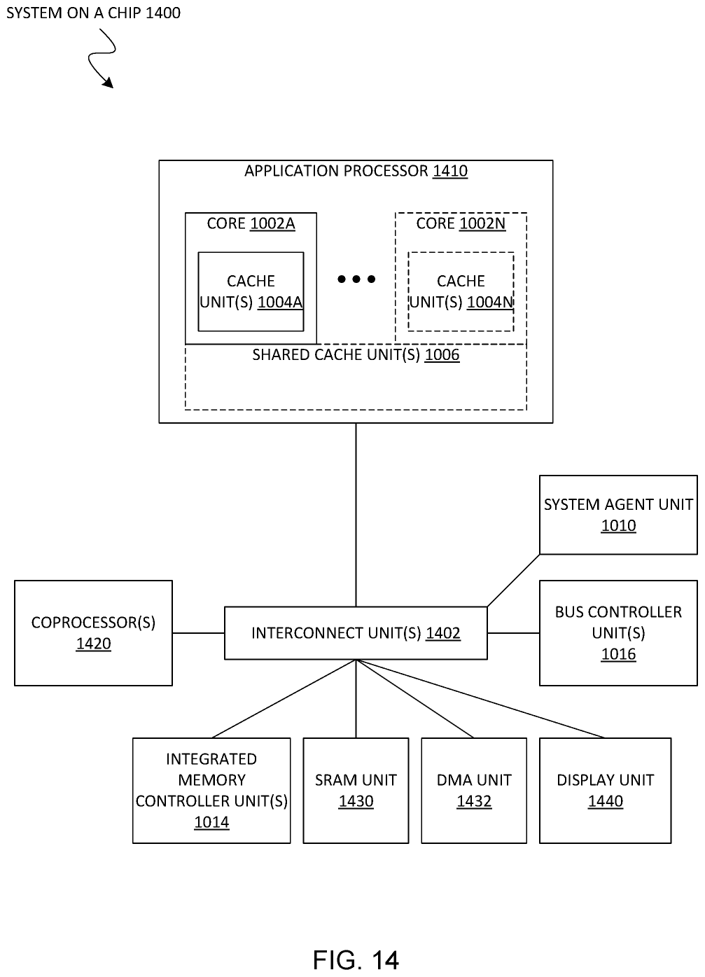

Referring now to FIG. 14, shown is a block diagram of a SoC 1400 in accordance with an embodiment of the present invention. Similar elements in FIG. 10 bear like reference numerals. Also, dashed lined boxes are optional features on more advanced SoCs. In FIG. 14, an interconnect unit(s) 1402 is coupled to: an application processor 1410 which includes a set of one or more cores 1002A-N and shared cache unit(s) 1006; a system agent unit 1010; a bus controller unit(s) 1016; an integrated memory controller unit(s) 1014; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

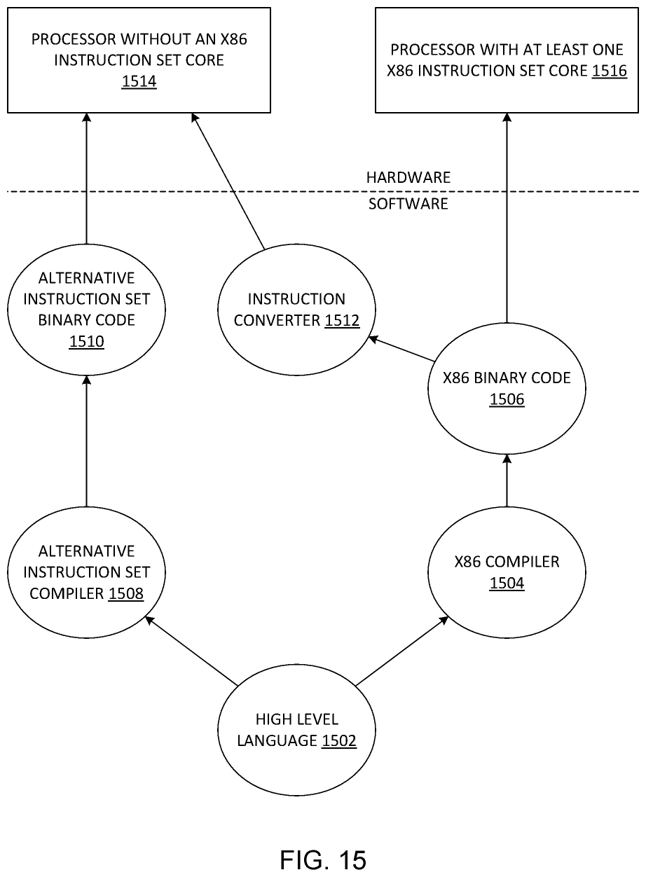

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

In one or more first embodiments, an integrated circuit comprises a repository to store first hashes which are each based on a different respective value which indicates a corresponding version of a Bitcoin protocol, a first scheduler to generate first message schedules each based on a different respective nonce value, and a first digest, a second scheduler and a second digest coupled in series with each other, the first digest to successively receive the first message schedules from the first scheduler, wherein for each message schedule of the first message schedules the first digest is to successively receive the first hashes from the repository, and to successively generate respective second hashes each based on both a different respective one of the first hashes, and the each message schedule, the second scheduler is to successively generate respective second message schedules each based on a different respective one of the respective second hashes, and the second digest is to successively generate respective third hashes each based on a different respective one of the respective second message schedules.

In one or more second embodiments, further to the first embodiment, the repository is to repeatedly provide the first hashes to the first digest in a first order.

In one or more third embodiments, further to the first embodiment or the second embodiment, the repository comprises a first-in, first-out (FIFO) buffer and circuitry to rebuffer one of the first hashes to the FIFO buffer.

In one or more fourth embodiments, further to any of the first through third embodiments, the first scheduler, the first digest, the second scheduler and the second digest are to perform a Secure Hash Algorithm 256 (SHA-256) computation.

In one or more fifth embodiments, further to any of the first through fourth embodiments, a total number of the first hashes is equal to n, wherein n is an integer, the integrated circuit further comprising circuitry to clock the first scheduler at a first frequency, and to clock the first digest at a second frequency which is equal to n times the first frequency.

In one or more sixth embodiments, further to any of the first through fifth embodiments, the integrated circuit further comprises a circuit block to calculate the first hashes each based on first bits of a Merkle root, wherein the first message schedules are each further based on second bits of the Merkle root.

In one or more seventh embodiments, further to the fifth embodiment, The integrated circuit of claim ##, the circuit block further to provide the first hashes to the repository prior to a generation of the respective second hashes for each message schedule of the first message schedules.

In one or more eighth embodiments, a system comprises an integrated circuit comprising a repository to store first hashes which are each based on a different respective value which indicates a corresponding version of a Bitcoin protocol, a first scheduler to generate first message schedules each based on a different respective nonce value, and a first digest, a second scheduler and a second digest coupled in series with each other, the first digest to successively receive the first message schedules from the first scheduler, wherein for each message schedule of the first message schedules the first digest is to successively receive the first hashes from the repository, and to successively generate respective second hashes each based on both a different respective one of the first hashes, and the each message schedule, the second scheduler is to successively generate respective second message schedules each based on a different respective one of the respective second hashes, and the second digest is to successively generate respective third hashes each based on a different respective one of the respective second message schedules. The system further comprises a display device coupled to the integrated circuit, the display device to display an image based on a signal communicated with the integrated circuit.

In one or more ninth embodiments, further to the eighth embodiment, the repository is to repeatedly provide the first hashes to the first digest in a first order.

In one or more tenth embodiments, further to the eighth embodiment or the ninth embodiment, the repository comprises a first-in, first-out (FIFO) buffer and circuitry to rebuffer one of the first hashes to the FIFO buffer.

In one or more eleventh embodiments, further to any of the eighth through tenth embodiments, the first scheduler, the first digest, the second scheduler and the second digest are to perform a Secure Hash Algorithm 256 (SHA-256) computation.

In one or more twelfth embodiments, further to any of the eighth through eleventh embodiments, a total number of the first hashes is equal to n, wherein n is an integer, the integrated circuit further comprising circuitry to clock the first scheduler at a first frequency, and to clock the first digest at a second frequency which is equal to n times the first frequency.

In one or more thirteenth embodiments, further to any of the eighth through twelfth embodiments, the integrated circuit further comprises a circuit block to calculate the first hashes each based on first bits of a Merkle root, wherein the first message schedules are each further based on second bits of the Merkle root.

In one or more fourteenth embodiments, further to the thirteenth embodiment, the circuit block is further to provide the first hashes to the repository prior to a generation of the respective second hashes for each message schedule of the first message schedules.

In one or more fifteenth embodiments, a method comprises storing at a repository first hashes which are each based on a different respective value which indicates a corresponding version of a Bitcoin protocol, generating, with a first scheduler, first message schedules each based on a different respective nonce value, at a first digest, successively receiving the first message schedules from the first scheduler, wherein the first digest, a second scheduler and a second digest are coupled in series with each other, and for each message schedule of the first message schedules with the first digest, successively receiving the first hashes from the repository, and successively generating respective second hashes each based on both a different respective one of the first hashes, and the each message schedule, with the second scheduler, successively generating respective second message schedules each based on a different respective one of the respective second hashes, and with the second digest, successively generating respective third hashes each based on a different respective one of the respective second message schedules.

In one or more sixteenth embodiments, further to the fifteenth embodiment, the repository repeatedly provides the first hashes to the first digest in a first order.

In one or more seventeenth embodiments, further to the fifteenth embodiment or the sixteenth embodiment, the repository comprises a first-in, first-out (FIFO) buffer and circuitry to rebuffer one of the first hashes to the FIFO buffer.

In one or more eighteenth embodiments, further to any of the fifteenth through seventeenth embodiments, the first scheduler, the first digest, the second scheduler and the second digest perform a Secure Hash Algorithm 256 (SHA-256) computation.

In one or more nineteenth embodiments, further to any of the fifteenth through eighteenth embodiments, a total number of the first hashes is equal to n, wherein n is an integer, the method further comprising clocking the first scheduler at a first frequency, and clocking the first digest at a second frequency which is equal to n times the first frequency.

In one or more twentieth embodiments, further to any of the fifteenth through nineteenth embodiments, the method further comprises calculating the first hashes each based on first bits of a Merkle root, wherein the first message schedules are each further based on second bits of the Merkle root.

In one or more twenty-first embodiments, further to the twentieth embodiment, the method further comprises providing the first hashes to the repository prior to a generation of the respective second hashes for each message schedule of the first message schedules.

Techniques and architectures for providing Bitcoin mining with version rolling are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit comprising:
a repository to store first hashes which are each based on a different respective value which indicates a corresponding version of a Bitcoin protocol;
a first scheduler to generate first message schedules each based on a different respective nonce value; and
a first digest, a second scheduler and a second digest coupled in series with each other, the first digest to successively receive the first message schedules from the first scheduler, wherein for each message schedule of the first message schedules:
the first digest is to successively receive the first hashes from the repository, and to successively generate respective second hashes each based on both a different respective one of the first hashes, and the each message schedule;
the second scheduler is to successively generate respective second message schedules each based on a different respective one of the respective second hashes; and
the second digest is to successively generate respective third hashes each based on a different respective one of the respective second message schedules.

2. The integrated circuit of claim 1, wherein the repository is to repeatedly provide the first hashes to the first digest in a first order.

3. The integrated circuit of claim 1, wherein the repository comprises a first-in, first-out (FIFO) buffer and circuitry to rebuffer one of the first hashes to the FIFO buffer.

4. The integrated circuit of claim 1, wherein the first scheduler, the first digest, the second scheduler and the second digest are to perform a Secure Hash Algorithm 256 (SHA-256) computation.

5. The integrated circuit of claim 1, wherein a total number of the first hashes is equal to n, wherein n is an integer, the integrated circuit further comprising circuitry to clock the first scheduler at a first frequency, and to clock the first digest at a second frequency which is equal to n times the first frequency.

6. The integrated circuit of claim 1, further comprising:
a circuit block to calculate the first hashes each based on first bits of a Merkle root, wherein the first message schedules are each further based on second bits of the Merkle root.

7. The integrated circuit of claim 6, the circuit block further to provide the first hashes to the repository prior to a generation of the respective second hashes for each message schedule of the first message schedules.

8. A system comprising:
an integrated circuit comprising:
a repository to store first hashes which are each based on a different respective value which indicates a corresponding version of a Bitcoin protocol;
a first scheduler to generate first message schedules each based on a different respective nonce value; and
a first digest, a second scheduler and a second digest coupled in series with each other, the first digest to successively receive the first message schedules from the first scheduler, wherein for each message schedule of the first message schedules:
the first digest is to successively receive the first hashes from the repository, and to successively generate respective second hashes each based on both a different respective one of the first hashes, and the each message schedule;
the second scheduler is to successively generate respective second message schedules each based on a different respective one of the respective second hashes; and
the second digest is to successively generate respective third hashes each based on a different respective one of the respective second message schedules; and
a display device coupled to the integrated circuit, the display device to display an image based on a signal communicated with the integrated circuit.

9. The system of claim 8, wherein the repository is to repeatedly provide the first hashes to the first digest in a first order.

10. The system of claim 8, wherein the repository comprises a first-in, first-out (FIFO) buffer and circuitry to rebuffer one of the first hashes to the FIFO buffer.

11. The system of claim 8, wherein the first scheduler, the first digest, the second scheduler and the second digest are to perform a Secure Hash Algorithm 256 (SHA-256) computation.

12. The system of claim 8, wherein a total number of the first hashes is equal to n, wherein n is an integer, the integrated circuit further comprising circuitry to clock the first scheduler at a first frequency, and to clock the first digest at a second frequency which is equal to n times the first frequency.

13. The system of claim 8, the integrated circuit further comprising:
a circuit block to calculate the first hashes each based on first bits of a Merkle root, wherein the first message schedules are each further based on second bits of the Merkle root.

14. The system of claim 13, the circuit block further to provide the first hashes to the repository prior to a generation of the respective second hashes for each message schedule of the first message schedules.

15. A method comprising:
storing at a repository first hashes which are each based on a different respective value which indicates a corresponding version of a Bitcoin protocol;
generating, with a first scheduler, first message schedules each based on a different respective nonce value;
at a first digest, successively receiving the first message schedules from the first scheduler, wherein the first digest, a second scheduler and a second digest are coupled in series with each other; and
for each message schedule of the first message schedules:
with the first digest, successively receiving the first hashes from the repository, and successively generating respective second hashes each based on both a different respective one of the first hashes, and the each message schedule;
with the second scheduler, successively generating respective second message schedules each based on a different respective one of the respective second hashes; and
with the second digest, successively generating respective third hashes each based on a different respective one of the respective second message schedules.

16. The method of claim 15, wherein the repository repeatedly provides the first hashes to the first digest in a first order.

17. The method of claim 15, wherein the repository comprises a first-in, first-out (FIFO) buffer and circuitry to rebuffer one of the first hashes to the FIFO buffer.

18. The method of claim 15, wherein the first scheduler, the first digest, the second scheduler and the second digest perform a Secure Hash Algorithm 256 (SHA-256) computation.

19. The method of claim 15, wherein a total number of the first hashes is equal to n, wherein n is an integer, the method further comprising:
clocking the first scheduler at a first frequency; and
clocking the first digest at a second frequency which is equal to n times the first frequency.

20. The method of claim 15, further comprising:
calculating the first hashes each based on first bits of a Merkle root, wherein the first message schedules are each further based on second bits of the Merkle root.
